(19) United States
(12) Patent Application Publication
(10) Pub. No.: US 2015/0175331 A1
(43) Pub. Date: Jun. 25, 2015

(54) PACKAGING STRUCTURE USING SIMPLE LATERAL SIDES

(71) Applicant: National Tsing Hua University, Hsinchu (TW)

(72) Inventors: DONGLIANG DANIEL SHEU, HSINCHU (TW); ERH-NING FANG, HSINCHU (TW); KANG-HUNG LIU, HSINCHU (TW); HSIN-HEN CHANG, HSINCHU (TW)

(73) Assignee: National Tsing Hua University, Hsinchu (TW)

(21) Appl. No.: 14/248,669

(22) Filed: Apr. 9, 2014

(30) Foreign Application Priority Data
Dec. 24, 2013 (TW) 102147915

(51) Int. Cl. B65D 81/02; B31B 43/00

(52) U.S. Cl. CPC B65D 81/025; B31B 43/00; B65D 2581/053

(57) ABSTRACT

A packaging structure and its fabrication method are disclosed herein. The packaging structure for holding an article in a box includes at least one first supporting portion. The first supporting portion is used for providing lateral support to the article, and the first supporting portion is formed by a lateral side of a first side of the paperboard. The packaging structure further includes a second supporting portion positioned at an area of the paperboard which is for bearing the main body of the article to provide a frontal supporting force of the paper to the article, wherein the second supporting portion can be planar or curve structure. In the present invention, all the structures in the lateral side and frontal side of the paperboard can be one-piece formed by punching the paperboard. The lateral side of the paperboard can provide lateral support and buffering protection to the article, which is convenient to manufacture.

### BACKGROUND OF THE INVENTION

1. Field of the Invention

The present invention relates to a packaging structure, and particularly to a packaging structure having a simple structure, securing with a lateral side of a non-linear paperboard, and protecting products.

2. Description of the Prior Art

Packaging structures formed by paper material for bearing or covering the product basically can be divided into two main categories: the pulp molded packaging structure and the folding box structure. The pulp molded method uses wood pulp with a suitable concentration, attaching-formed on a particular mold, and dried to form a lining of a packaging box, such as FIG. 1a. The folding box structure is made of paperboard to secure the product, and the paperboard is folded to fill the unused space between the product and the box to protect the product. To ensure products being capable of standing impacts due to dropping on the ground that may happen due to casually loading or moving during transportation (the dropping situation may often happen to the products having packaged), packaged products must be checked to pass a drop test before selling. The foregoing conventional product packaging structures both use a front side of a paperboard to form the packaging structure to package products. However, the impact energy absorbed by the front side of the paperboard is limited. A simple package usually cannot pass a drop test. If wanting to achieve enough protecting strength, the paperboard must further be folded into a more complicated structure. Such a complicated packaging structure must use plenty of paperboards. For example, multiple-layered double-walled corrugated paperboards may be folded for protecting products, such as FIG. 1b. Such a complicated packaging structure may waste more paper material and consume much operator time for manually folding paperboards. In addition, the operators need to be skillful to do the job right. Non skilled operators often cannot do the job properly.

Instead of using conventional frontal side of papers with complicated structure to protect products, this invention uses non-linear lateral side of the papers to protect the products. The advantages of this invention include: 1) consume minimum amount of paper materials; 2) do away with laborial paper folding by operators; 3) Easy to make. The whole packaging form can be achieved by a simple punch which cuts and forms the needed non-liner shape in one stroke. The key to the lateral strength is the non-linear shape of the packaging paper. Comparing the papers in FIGS. 3 a and 3b, other things being equal, due to the non-linear shape, paper in FIG. 3b often can sustain several times of lateral force than the flat linear paper in FIG. 3a without bulking. If the paper already can sustain lateral force by its composition, the non-linear shape can still sustain even much more forces than the already strong late paper.

### SUMMARY OF THE INVENTION

One embodiment of the present invention provides a packaging structure for holding an article in a box. The packaging structure is one-piece formed by a paperboard. The packaging structure comprises at least one first supporting portion. The first supporting portion is featured by using a lateral side of the paperboard to provide horizontal support to the article.

The packaging structure of the present invention can enhance protection of products inside the packaging box with a lateral side of a paperboard. The packaging structure of the present invention passed a drop test with even higher protection strength compared to its more complicated paper structure to its non-linear lateral side despite its simpler packaging structure. The packaging structure of the present invention can be formed by a punching apparatus, which may cut and fold the paperboard in one operation without operator folding involvements. No time is wasted to manually fold paperboards. Thus, the packaging structure of the present invention can have effects of saving material and manual operation cost.

Other advantages of the present invention will become apparent from the following illustrations and embodiment examples.

### BRIEF DESCRIPTION OF THE DRAWINGS

The foregoing aspects and many accompanying advantages of this invention will become more readily appreciated by reference to the following detailed descriptions, when taken in conjunction with the accompanying drawings, wherein:

FIG. 1a is a schematic diagram showing a pulp molded, conventional packaging structure;

FIG. 1b is a schematic diagram showing a conventional packaging structure formed by folding paperboards;

FIG. 2a is a schematic diagram showing that a packaging structure of the present invention is integrally formed by one paperboard;

FIG. 2b is a schematic diagram showing a packaging structure of one embodiment of the present invention which was achieved by a simple punch operation of the paper in FIG. 2a;

FIG. 3a is a schematic view showing a flat paperboard of the packaging structure at its initial stage, wherein the lateral strength of the paper to resist lateral force is dependent on the paper board size and thickness;

FIG. 3b is a schematic diagram showing a non-linear shape embodiment of the paperboard of FIG. 3a;

FIG. 3c, FIG. 3d, FIG. 3e, and FIG. 3f are schematic diagrams showing another non-linear shape embodiments of the paperboard of FIG. 3a, wherein the lateral shape of the non-linearity can be partial circular, rectangular, multiple laps;

FIG. 4a is a schematic diagram showing that after the packaging structure shown in FIG. 2b is put into a box, what is seen towards a direction A, where 300 is the product under protection;

FIG. 4b is a schematic diagram showing that after the packaging structure shown in FIG. 2b is put into the box, what is seen towards a direction B;

FIG. 5 is a schematic diagram showing a packaging structure of another embodiment of the present invention where under page of the protection layer is dented to store some useful elements such as desiccant and/or to absorb forces from underneath; and

FIG. 6 is a schematic diagram showing a packaging structure of still another embodiment of the present invention.

### DESCRIPTION OF THE PREFERRED EMBODIMENT

The present invention provides a packaging structure and a method for manufacturing the same. The packaging structure is one-piece formed by a paperboard. The packaging structure comprises at least one first supporting portion. The first supporting portion is formed by a non-linear lateral side of the paperboard on a first side of the paperboard, and is used for providing horizontal support to the article. In addition to the first supporting portion, the above-mentioned packaging structure may further comprise a second supporting portion. The second supporting portion is positioned at an area of the paperboard featured by using the frontal part of the paperboard to support the article often used but is not limited to provide a vertical supporting force to the article. The packaging structure of the present invention can be integrally formed by one-step punching with one paperboard, and provides lateral support to the article with the non-linear lateral side of the paperboard, thus can reduce cost, be more convenient for production, and provides good buffering protection for the article. Various embodiments of the present invention will be described in detail with regard to the attached drawings for illustration. In addition to these detail descriptions, the present invention can be widely implemented in other embodiments, and simple replacement, modification and equivalent alteration of any described embodiment are all included in the scope of the present invention which is based on the claims thereafter. In the following descriptions, the specification are set forth illustrating the Applicant's best mode for practicing the invention and enable ordinary skill in the art to make and use the invention. However, the present invention can be practiced without many of these particular details. Moreover, well-known steps or elements are not described in details, to avoid unnecessarily obscuring the present invention. Like parts or elements are referred to with like reference numbers. Further noted, the drawings are for illustration, and do not represent the actual size or number of elements. The parts of unrelated details are not drawn completely to simplify the drawings.

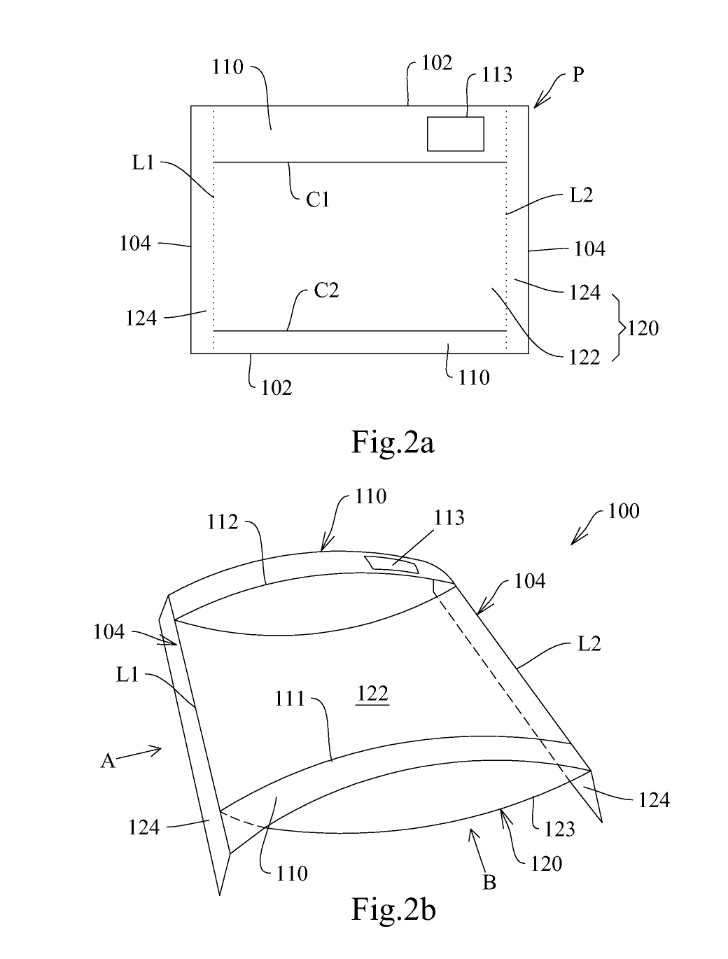

Refer to FIG. 2a and FIG. 2b, FIG. 2a is the shape of the paperboard and FIG. 2b is the perspective schematic views of the packaging structure of one embodiment of the present invention. The packaging structure is used for holding an article in a box, and is integrally formed by one paperboard. In the present embodiment, FIG. 2a shows a flat blank of the paperboard P, including but not limited to a rectangle. The paperboard P has at least two cutting lines C1, C2 and at least two folding lines L1, L2. In one embodiment of the present invention, one-step punching process which cuts, shapes (shaping process) and/or folds (folding process) the paperboard in FIG. 2a to form the perspective packaging structure of FIG. 2b. As shown in FIG. 2b, the packaging structure 100 comprises at least one first supporting portion 110. The first supporting portion 110 is formed by a lateral side of the paperboard P on a first side 102 of the paperboard P, and is used for providing horizontal support to the article. In one embodiment, the lateral side of the paperboard may be a non-linear lateral side 111, 112 of the paperboard. The non-linear lateral side 111, 112 of the paperboard can include but not limited to a curved surface, a surface with multiple straight lines, or a combination thereof.

Continuing with the foregoing descriptions, based on the required strength of the packaging structure, various paper materials having different properties may be chosen for the paperboard P, such as a corrugated paper, a gray cardboard, a kraft board, or a combination thereof. Moreover, although the cutting lines C1, C2 shown in FIG. 2a are linearly in parallel with the first sides 102 of the paperboard P, the cutting lines C1, C2 may be determined according to the shape of the article to be packaged, and may not limit to straight lines in parallel with the first sides of the paperboard. In one embodiment, as shown in FIG. 2b, an opening 113 is formed on the first supporting portion 110, for accommodating an accessory of the article. For example, the article may be an electronic product, and the accessory may be an external power adapter of the electronic product.

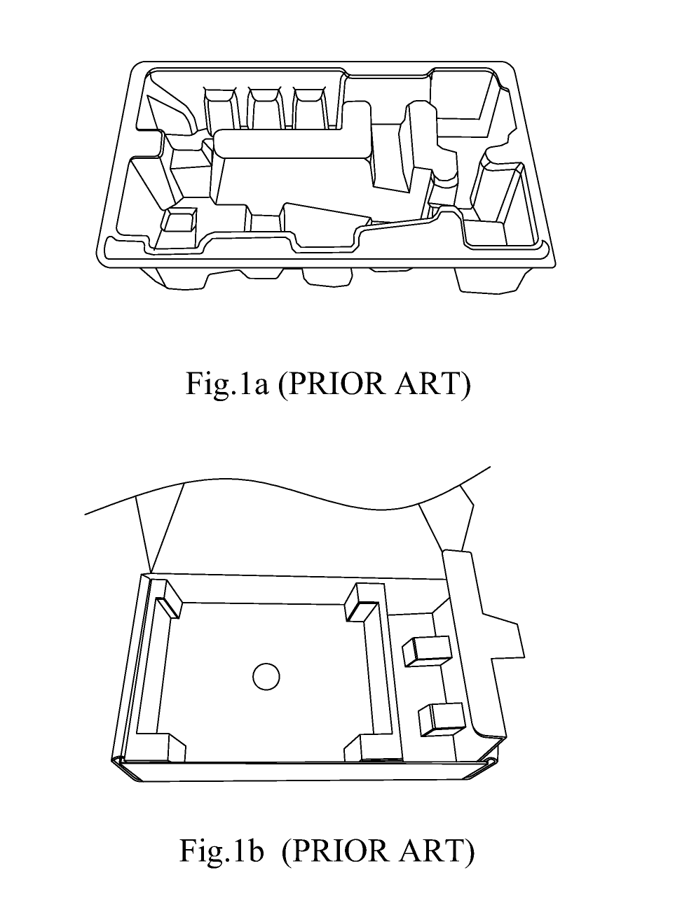

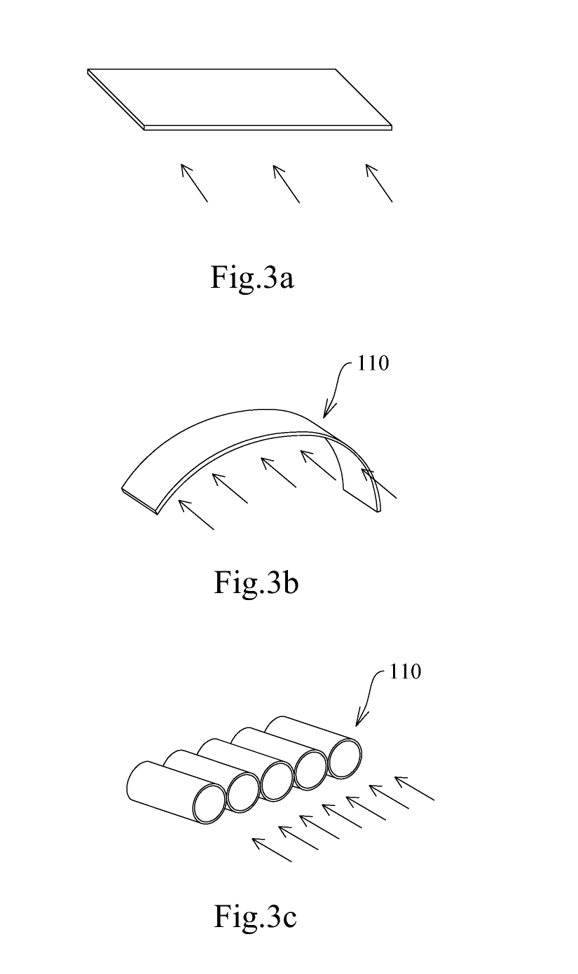

Continuing with the foregoing descriptions, referring to FIG. 3a and FIG. 3b, FIG. 3a shows a lateral side of a paperboard without a curved surface structure, and FIG. 3b shows a structure formed after the first supporting portion 110 is bent. FIG. 3b is a schematic diagram showing that the paperboard of FIG. 3a is formed into a non-linear shape. By way of non-linearity the paperboard can sustain much more forces. The type of non-linearity can be varied according to circumstances and needs, such as shown in FIG. 3c, FIG. 3d, FIG. 3e, and FIG. 3f. The lateral shape of the non-linearity can be partial circular, rectangular, multiple laps, etc. In these figures, the present invention is folded to form a first supporting portion on its lateral side. The lateral side of the paperboard without being bent may only endure a smaller lateral force (shown in the direction of the arrow), and may even not endure any lateral force. However, the first supporting portions 110, which bears the non-linear lateral sides of the paperboard as in FIG. 3b, may greatly enhance the ability of enduring the lateral force. The packaging structure of the present invention is tested under the drop test of the International Electrotechnical Commission (the test condition: performing 100 cm free fall for 1 corner, 3 edges and 6 sides of a packaged product). After the drop test, it is confirmed that the product still has normal function without any external scratch or damage. The result of this test indicates that the internal structural walls formed by lateral sides of the paperboard according to the present invention can more than satisfactorily absorb impact caused by dropping and protect the product from damage. The paperboard within the packaging structure only appeared a slight dent after dropped and can be easily restored to its original shape with hand adjustment. The experiment showed that the dent on the previous conventional folding paper structure had bigger dent and is harder to restore to its original shape After the above described drop test, it is proved that the packaging structure of the present invention has better buffering effect to absorb horizontal and vertical impacts than its previous conventional human-folded packaging structure as shown in FIG. 1b which use more paper materials and requires more time to fold into shape.

In another embodiment, as shown in FIG. 2a and FIG. 2b, the packaging structure 100 further comprises a second supporting portion 120 mainly positioned at an area of the paperboard P, such as the area 122 which is for bearing the main body of the article, so as to provide a vertical supporting force to the article. As shown in FIG. 2b, a surface of the second supporting portion 120 at least comprises a curved surface 123, but it may be understood that the second supporting portion may be a flat surface. In the embodiment of FIG. 2b, the curved surface 123 may be a U-shaped curved surface. Two supporting wings 124 may be formed respectively at two opposed sides of the U-shaped curved surface, and may be folded downwardly from the two opposed sides of the U-shaped curved surface. The two supporting wings 124 may be located respectively at opposed second sides 104 of the paperboard P.

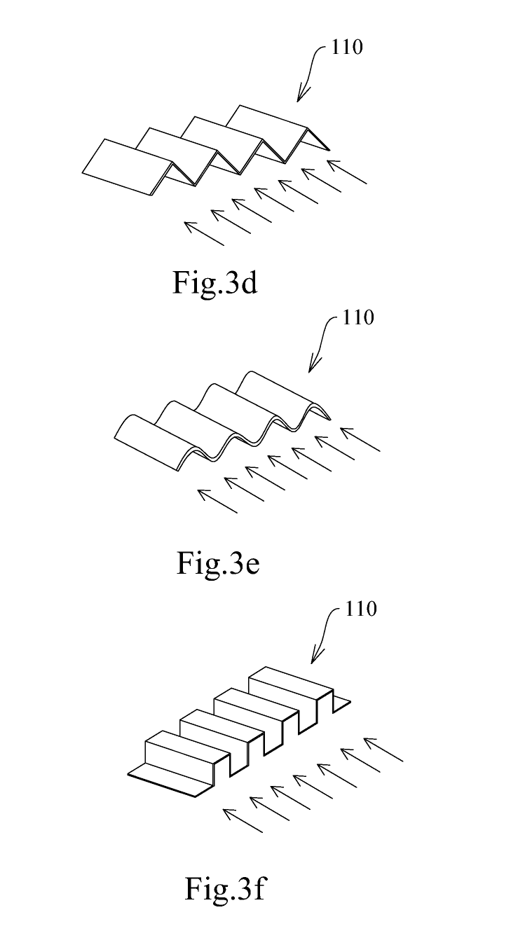

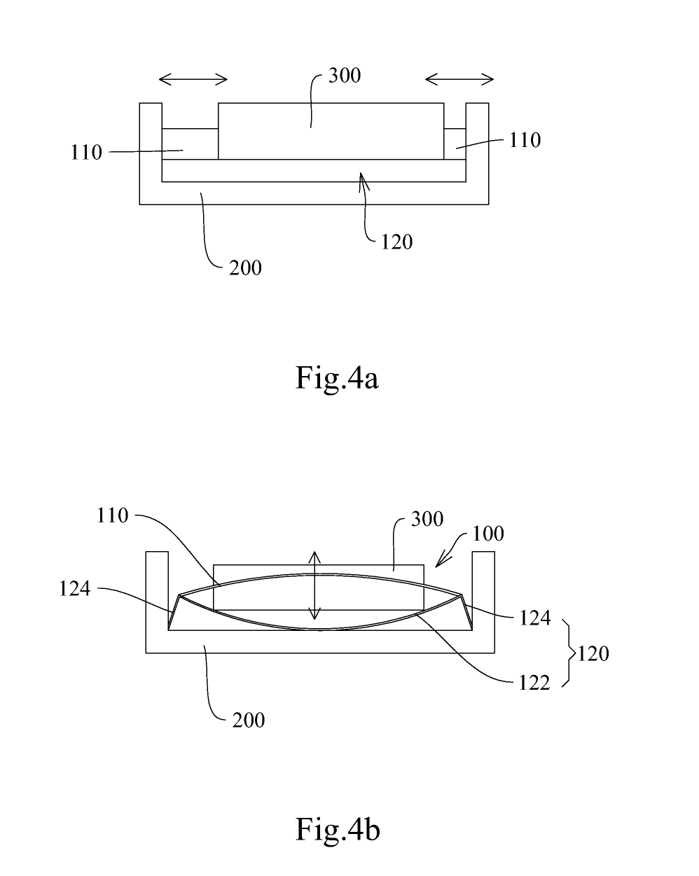

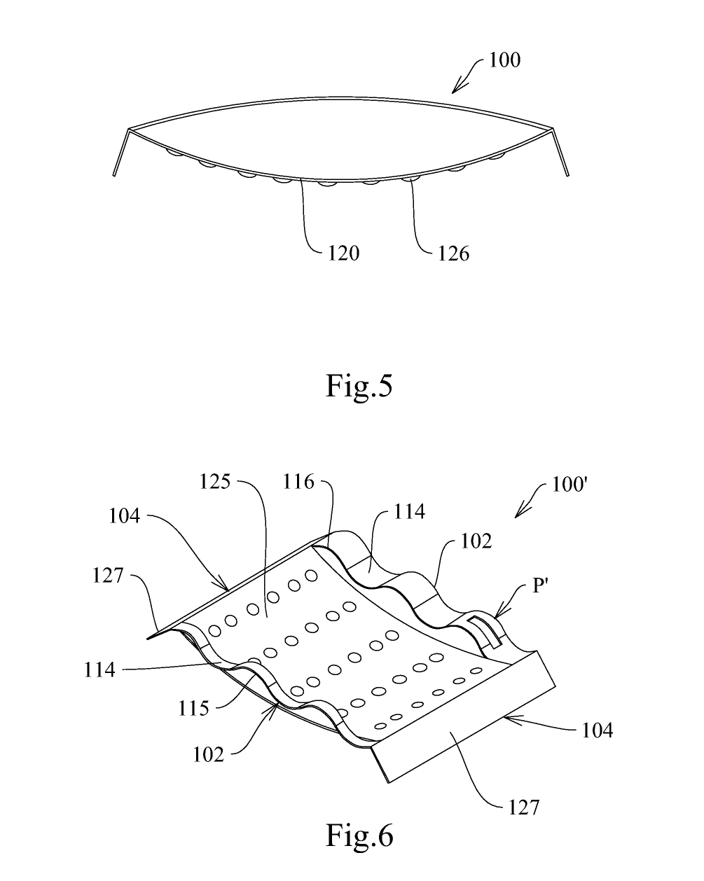

Continuing with the foregoing descriptions, refer to FIG. 4a and FIG. 4b. FIG. 4a is a schematic diagram illustrating the inner structure of a box in a direction A after the packaging structure shown in FIG. 2b is put into the box. FIG. 4b is a schematic diagram showing the inner structure of the box in a direction B after the packaging structure shown in FIG. 2b is put into the box. FIG. 4a and FIG. 4b are respectively for illustrating the horizontal supporting force and vertical supporting force. As shown in FIG. 4a, after the article 300 is put into the box 200 containing the proposed packaging structure, the first supporting portions 110 may abut against both left and right sides of the article 300 and hold it firmly in place. It can be known from the explanations in FIG. 3a and FIG. 3b that a non-linear curved surface can provide a better performance for resisting lateral forces, so that the first supporting portions 110 can provide a better horizontal supporting force for the article 300. In the same way, as shown in FIG. 4b. In this embodiment, after the second supporting portion 120 is dented as shown in FIGS. 5 and 6, the combination of the U-shaped curved surface of the second supporting portion 120, the dented protrusions on it, and the two downwardly-folded supporting wings 124 together can provide buffer space and a better vertical force absorption for the article 300 if hit from below due to dropping. Moreover, as shown in FIG. 4b, the two supporting wings 124 may support the curved surface 123 from two sides, such that the curved surface 123 is spaced from a bottom of the box 200 for a gap. The space between the bottom of the box 200 and the curved surface 123 may be used to accommodate some accessory of the article 300. The space may also be used for accommodating buffering material, so as to strengthen the vertical supporting force.

Moreover, in yet one embodiment, as shown in FIG. 5, a plurality of protruded structures 126 are protruded from and/or recessed into a surface of the second supporting portion 120. These protruded structures 126 may also be completed in the same one-step punching process of the simple non-linear package board. In addition to absorbing the impact from below the article, the protruded structures 126 may also be filled with buffering material, a desiccant, anti-rust materials, and/or aromatic materials, etc. as appropriate to achieve additional relevant functions. The above-mentioned material may fill gaps between the product housing and inner walls of the box, so as to enhance buffering effects to enhance the ability of protecting the product. The present invention has another advantage. Upon forming the packaging structure, cutting the paperboard, forming the first/second supporting portions and forming the protruded structures on the surfaces of the first/second supporting portions can all be completed with one punch operation, and its forming time can be one tenth or less than that of a conventional manual folding paperboards. In the above-mentioned embodiment, it may take less than 0.5 seconds to complete the packaging structure with one-time punching process, but in previous practices, it may take at least 25 seconds with a conventional manual folding. Besides, the present invention may use a punching apparatus to form the packaging structure, which is more convenient in mass production and rapid manufacturing. However, a conventional manner of folding paperboards it requires manual operations due to the structure complexity.

Yet one embodiment of the present invention is shown in FIG. 6. A packaging structure 100′ is used for holding an article in a box, and the packaging structure 100′ is integrally formed by one paperboard. What differs from the above-mentioned embodiments is that the packaging structure 100′ has two strip-shaped paperboards 114 located at two first sides 102 of a paperboard P′. A central area between these two strip-shaped paperboards 114 may be a U-shaped curved surface 125 having an upward notch-mouth, and lateral sides of the two strip-shaped paperboards 114 may form non-linear lateral sides 115, 116. The U-shaped curved surface 125 is used for bearing the article, and the two non-linear lateral sides 115, 116 of the two strip-shaped paperboards 114 are used for securing lateral sides of the article. Two supporting wings 127 may be formed respectively at two opposed sides of the U-shaped curved surface 125, and may be folded downwardly, opposed to the direction of the notch-mouth, from the two opposed sides of the U-shaped curved surface 125. The two supporting wings 124 may be located respectively at opposed second sides 104 of the paperboard P to support two ends of the U-shaped curved surface 125. In the embodiment of FIG. 6, the non-linear lateral sides 115, 116 has a wave-shaped curved surface, and it may be understood that the non-linear lateral sides 115, 116 may have a zigzag straight-edged surface (not shown) or other geometry. Moreover, it may be known from FIG. 6 that widths of the two strip-shaped paperboards 114 may be modified according to user design requirements. As long as the lateral sides of the two strip-shaped paperboards may abut against at least one side of the article to provide horizontal supporting forces to the article, designs with any geometry may be acceptable. The detail descriptions of what are the same as the above-mentioned embodiments are omitted herein.

Besides, a method for forming the packaging structure is disclosed. The method is used for manufacturing the packaging structures according to the above-mentioned embodiments, thereby forming the packaging structure by punching process with one paperboard, wherein the punching process comprises a cut and/or trim process to cut the paperboard and at least one of a shaping process to shape the cut paperboard, and a folding process to bend the cut paperboard. The punching process is simple and can reduce manufacture time and cost.

According to the foregoing descriptions, an objective of the present invention is using a lateral side of the paperboard to secure and support a product. With a curved surface of the paperboard. If paper material that can endure a higher lateral force is used, the buffering effects can be further enhanced. Besides, forming structural space is needless and folding the board paper is also needless, so that the cost of manually folding and paper material can be much reduced. Besides, using a one-step punching process to form the packaging shape can achieve benefits of saving paper materials, labor cost and operation time, so that cost can be much reduced. Moreover, the surface of the packaging structure can be stamping molded with a 3D notch-and-ridge structure as required, which can, in addition to absorbing impacts, form more accommodating space to dispose various functional materials as required, such as a desiccant, an antirust, an aromatic etc., and can further provide additional functions in addition to physically protect products.

To sum up the foregoing descriptions, the packaging structure and a method for manufacturing the packaging structure of the present invention can be integrally formed by one paperboard, and can save paper materials, as compared to a conventional packaging structure combined by multiple paperboards. Moreover, using a punching apparatus, cutting the paperboard and making the paperboard form a non-linear curved surface by a punching manner can be fast for mass production, thereby saving the required operation time of a conventional packaging structure by manual folding or pasting paperboards. As compared to the conventional complex packaging structure in actual tests, when providing sufficient strength to protect products, the simple packaging structure of the present invention can save 52.7% of the paper material, and by using a punching apparatus to replace manual folding paperboards and packaging, the simple packaging structure of the present invention can save 61% of operation time.

While the invention can be subject to various modifications and alternative forms, a specific example thereof has been shown in the drawings and is herein described in detail. It should be understood, however, that the invention is not to be limited to the particular form disclosed, but on the contrary, the invention is to cover all modifications, equivalents, and alternatives falling within the spirit and scope of the appended claims.

What is claimed is:

1. A packaging structure, used for holding an article in a box and one piece formed by a paperboard, the packaging structure comprising:
at least one first supporting portion of the paperboard, which uses its lateral side to support the article.

2. The packaging structure according to claim 1, wherein the lateral side of the paperboard is a non-linear lateral side of the paperboard.

3. The packaging structure according to claim 2, wherein the non-linear lateral side of the paperboard has a circular shaped surface, a wave-shaped curved surface, a zigzag surface, or combinations thereof.

4. The packaging structure according to claim 1, wherein the first supporting portions are arranged at multiple parts of the paperboard.

5. The packaging structure according to claim 1, wherein an opening is formed in the first supporting portion, for accommodating a related component of the article.

6. The packaging structure according to claim 1, wherein the first supporting portion has at least one protruded structures which are protruded from and/or recessed into a surface of the first supporting portion, for enhancing buffering or accommodating functional materials.

7. The packaging structure according to claim 1, further comprising:
a second supporting portion, positioned at an area of the paperboard, which uses its frontal surface to support the article, wherein the second supporting portion has a curved surface or a flat surface.

8. The packaging structure according to claim 7, wherein an opening is formed in the second supporting portion, for accommodating a related component of the article.

9. The packaging structure according to claim 7, wherein the second supporting portion has at least one protruded structures which are protruded from and/or recessed into the surface of the second supporting portion, for enhancing buffering or accommodating functional materials.

10. The packaging structure according to claim 1, wherein the paperboard is a corrugated paper, a gray cardboard, a kraft board, or combination thereof.

11. A method for manufacturing a packaging structure, which forms a paperboard through one-step punching process, wherein the packaging structure comprises:
at least one first supporting portion formed by a lateral side of the paperboard to support an article.

12. The method according to claim 11, wherein the punching process comprises a trim function for cutting the paperboard and/or at least one of a shaping function to shape the cut paperboard, and/or a folding function to bend the cut paperboard.

13. The method according to claim 11, wherein the lateral side of the paperboard is a non-linear lateral side of the paperboard.

14. The method according to claim 13, wherein the non-linear lateral side of the paperboard has a circular surface, wave-shaped curved surface, a zigzag surface, or combinations thereof.

15. The method according to claim 11, wherein the first supporting portions are arranged at multiple parts of the paperboard.

16. The method according to claim 11, wherein an opening is formed on the first supporting portion for accommodating a related component of the article.

17. The method according to claim 11, wherein the first supporting portion has a plurality of protruded structures which are protruded from and/or recessed into a surface of the first supporting portion, for enhancing buffering or accommodating functional materials.

18. The method according to claim 11, further comprising:
a second supporting portion, positioned at an area of the paperboard, which uses its frontal side to support the article, wherein the second supporting portion has a curved surface or a flat surface.

19. The method according to claim 18, wherein the second supporting portion has at least one protruded structures which are protruded from and/or recessed into the surface of the second supporting portion, for enhancing buffering or accommodating functional materials.

20. The method according to claim 11, wherein the paperboard is a corrugated paper, a gray cardboard, a kraft board, or combination thereof.
